(19) United States
(12) Patent Application Publication
(10) Pub. No.: US 2009/0100045 A1
(43) Pub. Date: Apr. 16, 2009

(54) DEVICE AND METHOD FOR ADAPTIVE SERVICE SELECTION, QUERY SYSTEM AND METHOD

(75) Inventors: Qiangze Feng, Beijing (CN); Toshikazu Fukushima, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 12/239,223

(22) Filed: Sep. 26, 2008

(30) Foreign Application Priority Data
Sep. 30, 2007 (CN) 200710180649.6

(51) Int. Cl. G06F 17/30

(52) U.S. Cl. 707/5; 707/E17.068

(57) ABSTRACT

The present invention relates to a device for adaptive service selection comprising a semantic analyzing means which analyzes a query from a user semantically, an adaptive service selecting means which generates a new service mapping rule so as to obtain a selected service, when the semantically-analyzed query does not match with a rule in a service mapping rule base, and a retrieving means which retrieves and obtains an answer according to the selected service. The present invention also relates to a method for adaptive service selection, a system and method for adaptive service selection as well as a query system and method thereof. With the system and method of the present invention, a new service mapping rule can be generated and added automatically when a user query is not included in a service mapping rule base. It is thus possible to improve the accuracy of natural language based service selection and provide the user with a selected service as well as the corresponding query answer.

### BACKGROUND OF THE INVENTION

1. Field of Invention

The present invention relates to the field of natural language processing, and in particular to a device and method for adaptive service selection, a system and method for adaptive service selection as well as a query system and method.

2. Description of Prior Art

With the continuous development of the information technology, it becomes desirable that any required information can be queried and found in a rapid and convenient way. In order to meet various query requirements from users, relevant companies have offered all kinds of services, such as traffic service, yellowpage service, weather service and the like, regarding almost all aspects of our life. A service selection system based on natural language allows a user to query various services with natural language, and then the system selects any service corresponding to the user's query from these services and feeds the answer back to the user.

The conventional service selection system generally finds out the service corresponding to the user's query in natural language according to certain predefined service mapping rules. If some flexible natural language query is not encompassed by the predefined service mapping rules, however, the system fails to find the service corresponding to the user query, and thus the user cannot obtain the expected service.

Patent Application No. JP2002351913 proposes a method in which a web service having optimal waiting time can be selected from all types of web services according to the history of user access to these web services (which particularly contains user name, longest waiting time, service type, latest access time, etc.) so as to avoid excessive load on network and service.

Patent Application No. JP2004054781 discloses a method which can extracts key words for retrieval from a user query in natural language and then select from various services the service and its invocation interface corresponding to the key words for retrieval.

Patent Application No. JP2004288118 provides a method which can, based on service register data supplied by a service provider, select a service corresponding to a user query and other services relevant to the service from a plurality of services.

In conclusion, all the existing methods find a service corresponding to a user query based on certain predefined service mapping rules, and thus neither of them can handle a user query uncovered by the service mapping rules as well as automatically find any new service mapping rule. It remains as a difficult and critical problem that how to process a query uncovered by the predefined service mapping rules and to automatically find any new service mapping rule.

### SUMMARY OF THE INVENTION

The present invention is made to address the above problems. The present invention provides an adaptive service selection device and method as well as a query system and method, which can dynamically generate a service mapping rule not contained in a service mapping rule base predefined in the system so that a service corresponding to a query entered by a user can be found by adding the corresponding service mapping rule even if it is not included in the service mapping rule base. The system of the present invention improves accuracy in natural language service selection since it can not only process a natural language query covered by predefined service mapping rules but also handle any natural language query not included in these rules and automatically find a new service mapping rule.

According to the first aspect of the present invention, a device for adaptive service selection is provided, comprising: a semantic analyzing means which analyzes a query from a user semantically; an adaptive service selecting means which generates a new service mapping rule so as to obtain a selected service, when the semantically-analyzed query does not match with a rule in a service mapping rule base; and a retrieving means which retrieves and obtains an answer according to the selected service.

According to the second aspect of the present invention, a method for adaptive service selection is provided, comprising: a semantic analyzing step of analyzing a query from a user semantically; an adaptive service selecting step of generating a new service mapping rule so as to obtain a selected service, when the semantically-analyzed query does not match with a rule in a service mapping rule base; and a retrieving step of retrieving and obtaining an answer according to the selected service.

A system for adaptive service selection and the related method are provided according to the third and fourth aspects of the present invention.

According to the fifth aspect of the present invention, a query system is provided, comprising: a query receiver which receives a query from a user; a semantic analyzing device which analyzes the query semantically; a determining device which determines whether a rule accurately matched with the query can be found in a service mapping rule base, and sends the semantically analyzed query to an accurate service selecting device or an adaptive service selecting device; an accurate service selecting device which extracts from the accurately matched rule a service type to which the query belongs so as to obtain a first selected service; an adaptive service selecting device which generates a new service mapping rule so as to obtain a second selected service, when the accurately matched rule can not be found in the service mapping rule base; a retrieving device which retrieves and obtains an answer according to the first selected service or the second selected service; and an answer sender which sends the retrieved answer to the user.

According to the sixth aspect of the present invention, a query method is provided, comprising: a query receiving step of receiving a query from a user; a semantic analyzing step of analyzing the query semantically; a determining step of determining whether a rule accurately matched with the user query can be found in a service mapping rule base, and sending the semantically analyzed query to an accurate service selecting step or an adaptive service selecting step; an accurate service selecting step of extracting the service type and service parameters from the accurately matched rule, so as to obtain a first selected service; an adaptive service selecting step of generating a new service mapping rule so as to obtain a second selected service, when the accurately matched rule can not be found in the service mapping rule base; a retrieving step of retrieving and obtaining an answer according to the first selected service or the second selected service; and an answer sending step of sending the retrieved answer to the user.

### BRIEF DESCRIPTION OF THE DRAWINGS

FIG. 1a is a schematic diagram showing a system for adaptive service selection according to the present invention;

FIG. 1b is a flowchart showing a method for adaptive service selection according to the present invention;

FIG. 2a is an exemplary block diagram showing a service mapping rule base according to the present invention;

FIG. 2b is a flowchart showing a method for generating the service mapping rule base;

FIG. 3 is an exemplary block diagram showing a user query history base according to the present invention;

FIG. 4 is a schematic diagram showing a semantic analyzing means known in the art;

FIG. 5a is a schematic diagram showing a device for adaptive service selection according to the present invention;

FIG. 5b is a flowchart showing a method for adaptive service selection according to the present invention;

FIG. 6a is a schematic diagram showing an adaptive service selecting section based on the service mapping rule base according to the present invention;

FIG. 6b is a flowchart showing an adaptive service selecting method based on the service mapping rule base according to the present invention;

FIG. 6c shows an example of adaptive service selection based on the service mapping rule base;

FIG. 7a is a schematic diagram showing an adaptive service selecting section based on the user query history base according to the present invention;

FIG. 7b is a flowchart showing an adaptive service selecting method based on the user query history base according to the present invention;

FIG. 7c shows an example of adaptive service selection based on the user query history base;

FIG. 8a is a schematic diagram showing an adaptive service selecting section based on a service response according to the present invention;

FIG. 8b is a flowchart showing an adaptive service selecting method based on the service response according to the present invention;

FIG. 8c shows an example of adaptive service selection based on the service response;

FIG. 9 is a block diagram showing a query system according to the present invention;

FIG. 10 is an example showing how to obtain an accurate query according to the present invention;

FIGS. 11a and 11b show a device for adaptive service selection used in a mobile terminal and an ASP, respectively;

FIGS. 12a and 12b show flowcharts of two methods for retrieval control, respectively.

### DETAILED DESCRIPTION OF PREFERRED EMBODIMENTS

Hereafter, a description will be made to the preferred embodiments of the present invention with reference to the figures, throughout which like elements are denoted by like reference symbols or numbers. In the following description, the details of any known function or configuration will not be repeated, otherwise they may obscure the subject of the present invention.

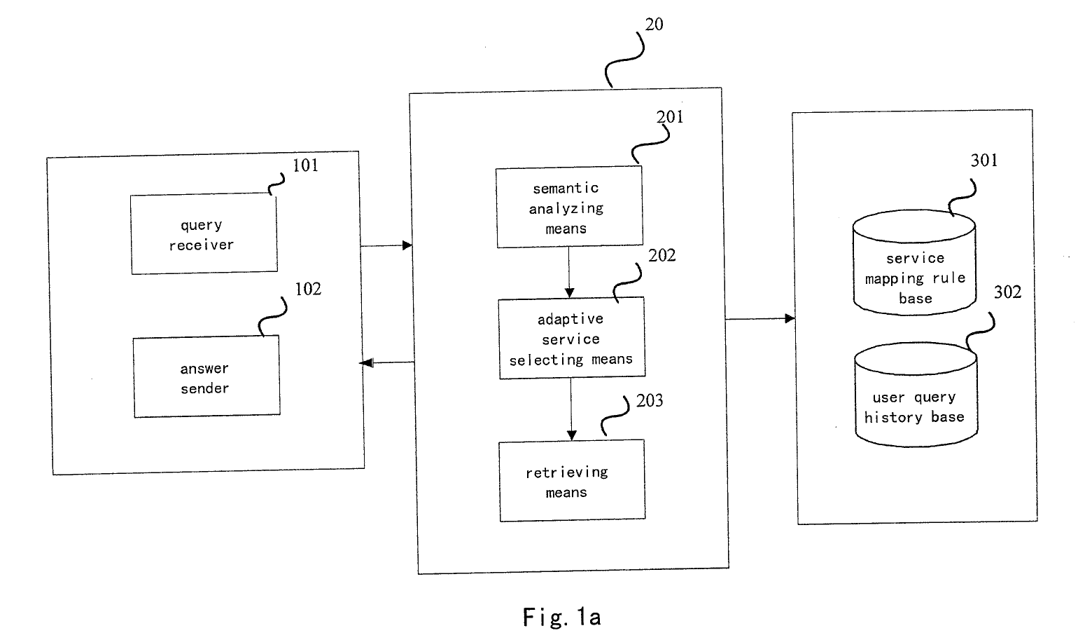

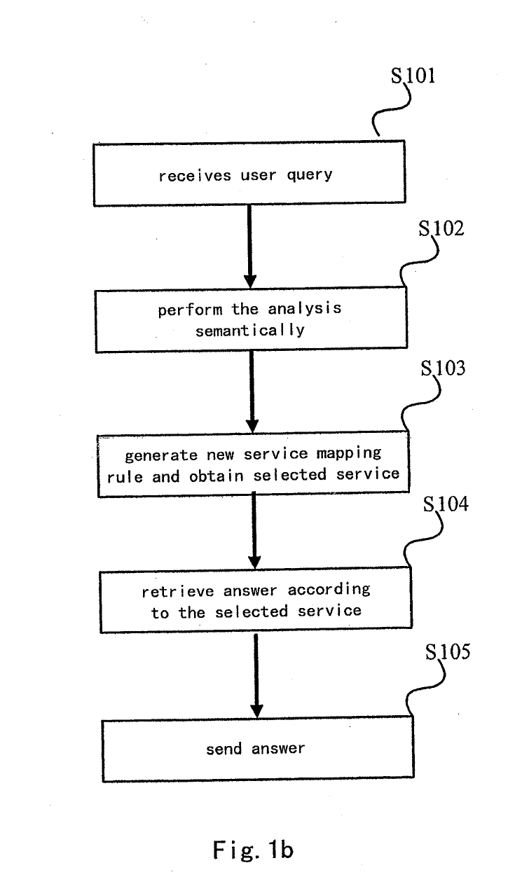

FIG. 1a is a schematic diagram showing a system for adaptive service selection according to the present invention. The system comprises a receiving/transmitting device, an adaptive service selecting device 20 and a storage device. The receiving/transmitting device includes a query receiver 101 for receiving a natural-language-based user query inputted by a user via a mobile terminal, such as a mobile phone, an answer sender 102 for sending to the user a retrieved answer corresponding to the user query. The storage device includes a service mapping rule base 301 and a user query history base 302. The adaptive service selecting device 20 functions to process a query that can be covered by neither of the service mapping rules in the service mapping rule base and add a new service mapping rule automatically, so that a service corresponding to the user query can be selected from all the service contained in the service mapping rule base even if neither of the service mapping rules in the base can match with the user query. The adaptive service selecting device 20 comprises a semantic analyzing means 201 which analyzes the received natural language query to obtain a structured semantic analysis result, an adaptive service selecting means 202 which supplements the rules in the service mapping rule base 301 by searching the service mapping rule base 301 and the user query history base 302 based on the semantic analysis result or by utilizing an retrieved answer from a service provider so as to obtain a selected service, a retrieving means 203 which retrieves and obtains an answer based on the selected service. Alternatively, the system can access a service mapping rule base and a user query history base external to the system instead of including internally the service mapping rule base 301 and the user query history base 302.

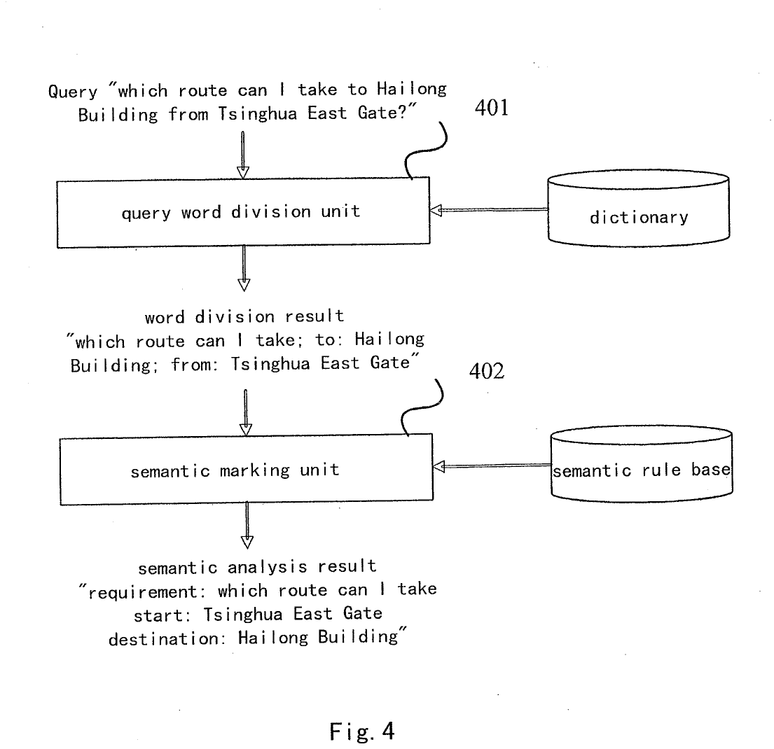

FIG. 1b shows a flowchart of the method for adaptive service selection. At S101, the query receiver 101 receives a natural-language-based user query sent from a user via a mobile terminal, such as a mobile phone, and transmits the query to the semantic analyzing means 201, which analyzes the received natural-language-based user query at S102. FIG. 4 shows a block diagram of a prior art semantic analyzing means, which serves to understand the user's natural language query so as to obtain a structured semantic analysis result and includes a query word division unit 401 and a semantic marking unit 402. The query word division unit 401 performs word division on the natural language query with a word lexicon, such as a dictionary, and then the semantic marking unit 402 performs semantic marking on the division result based on a semantic rule base so as to generate the semantic analysis result, which is usually formed of a requirement and a query parameter. The latter can comprises a set of parameters each having a corresponding parameter value. Referring to FIG. 4, for example, if the user query is “which route can I take to Hailong Building from Tsinghua East Gate?”, this natural language query is subjected to word division by the query word division unit 401 to generate a word division result “which route can I take; to; Hailong Building; from; Tsinghua East Gate”. Then, the result undergoes semantic analysis by the semantic marking unit 402. Specifically, according to the semantic knowledge “from<start>to<destination>”, the parameter value “Tsinghua East Gate” can correspond to “start”, and the parameter value “Hailong Building” can correspond to “destination”. Also, the interrogative phrase “which route can I take” can be extracted as the requirement. Eventually, the obtained result is “requirement: which route can I take, start: Tsinghua East Gate, destination: Hailong Building”.

At S103, when not finding any matched service mapping rule in the service mapping rule base, the adaptive service selecting means 202 can supplement the service mapping rule base automatically, that is, the adaptive service selecting means 202 supplements the rules in the service mapping rule base 301 by searching the service mapping rule base 301 and the user query history base 302 based on the semantic analysis result or by interacting with a service provider and utilizing an retrieved answer from the service provider, so as to obtain a selected service.

At S104, the retrieving means 203 retrieves a corresponding answer based on the selected service.

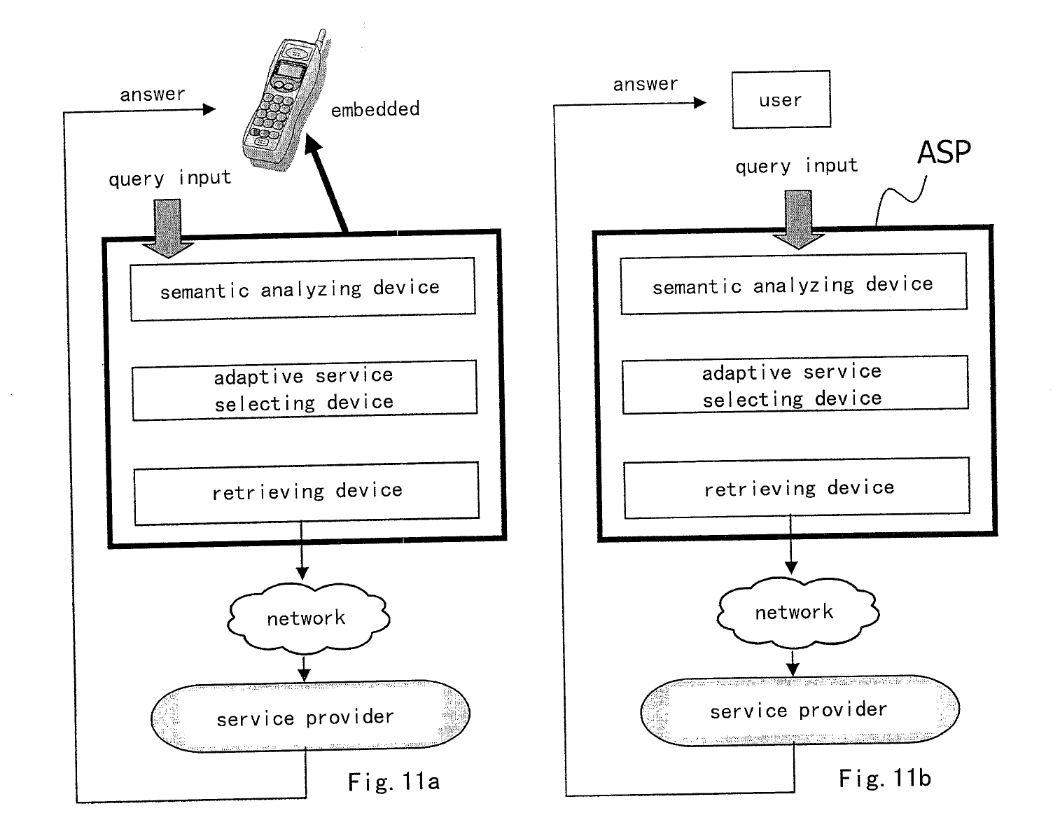

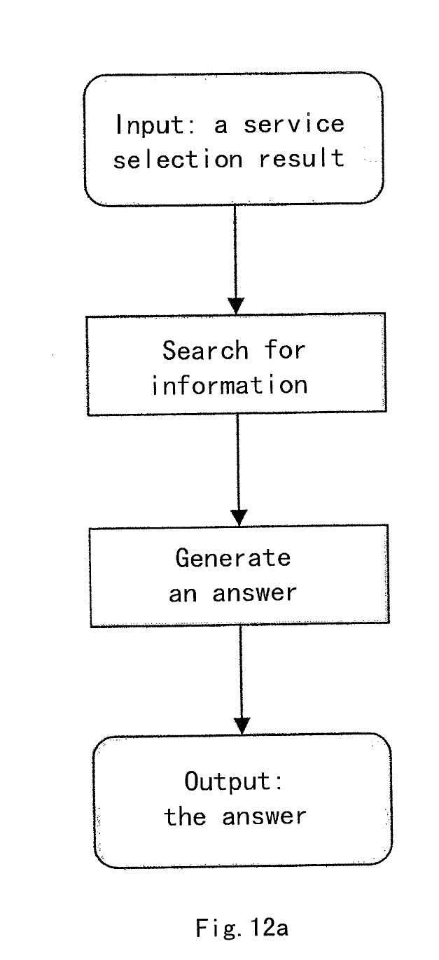

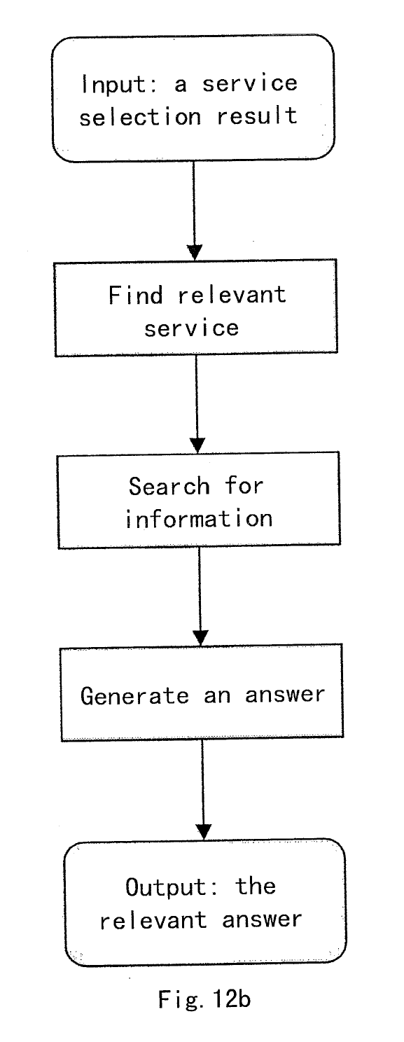

The retrieving means 203 may return only the answer corresponding to the user query, as shown in FIG. 11a, through a method comprising steps of:

(1) information search, that is, finding the service provider corresponding to the service type in the selected service and then sending the service parameters in the selected service to the service provider which will search and return a corresponding retrieved result; and
(2) answer generation, that is, generating the final answer according to the retrieved result returned by the service provider.

An integration is required for respective retrieved results if there are a number of service providers. The integration can be implemented in any relevant known method, such as ranking these results based on the credit standing of each service provider.

For the above example of the user query “which route can I take to Hailong Building from Tsinghua East Gate?”, according to the selected service “service type: route; start: Tsinghua East Gate; destination: Hailong Building”, the system can find service providers corresponding to the service type “route”, such as Baidu map, Sogou map, Google map, etc., then sends the parameters “start: Tsinghua East Gate; destination: Hailong Building” to these service provider and receives and integrates the retrieved results from them.

The retrieving means 203 can also return other relevant answers, as shown in FIG. 11b in which there is a step of finding relevant services, that is, finding other services relevant to the user query. For example, when a user queries how to get to a place, the system can provide information of relevant services, such as weather, traffic and the like in addition to the provided route. This can be realized in a prior art manner, for example, predefining a service relevancy table for recording relevancy between different service types and then finding a relevant service type on the basis of the service relevancy table.

The retrieved answer is sent to the user terminal by the answer sender 102 at S105.

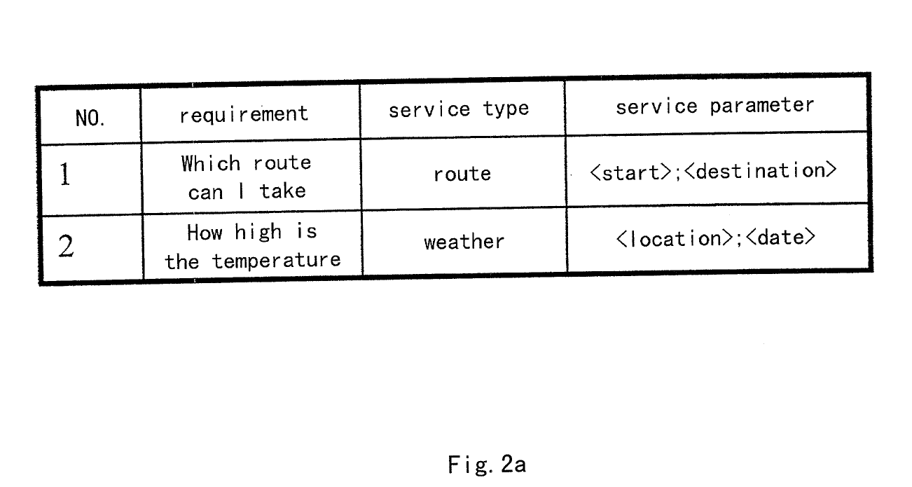

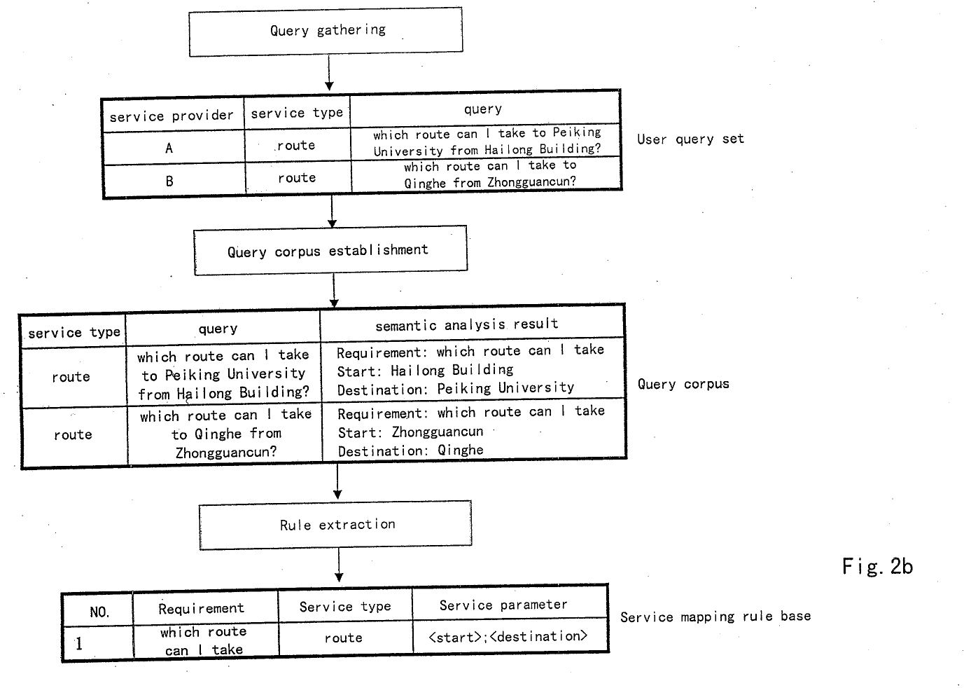

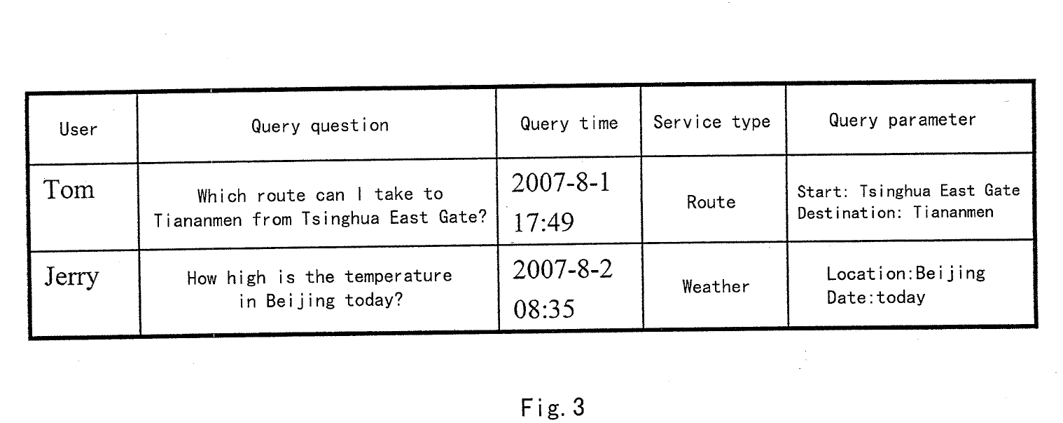

In the present invention, the system for adaptive service selection utilizes the service mapping rule base 301 and the user query history base 302 to add a service mapping rule not included in the service mapping rule base 301 and therefore selects a service corresponding to the user query. Accordingly, the following description is made to the service mapping rule base and the user query history base with respect to FIGS. 2a, 2b and 3. Then, a detailed explanation will be given to how the adaptive service selecting means 202 in the system supplements the service mapping rule base by utilizing the service mapping rule base and the user query history base.

The service mapping rule base 301 stores multiple sets of service mapping rules. When the match is established between the user query in natural language and a service mapping rule in the service mapping rule base 301, a service corresponding to the rule can be found as the service selected from all services contained in the service mapping rule base.

As shown in FIG. 2a, one piece of service mapping rule is generally composed of serial number, requirement, service type and service parameters. The requirement represents what is the question from the user query, that is, what service is related to the answer expected by the user. The service type defines the service category to which the query question belongs. The service parameters describe service type and service invocation interface, and the service provider can conduct retrieval based on service parameters. Each piece of rule stored in the service mapping rule base 301 represents “when a user query conforms to a specified requirement, which service type the query corresponds to and what is the corresponding service parameter”. Take the first piece of mapping rule in FIG. 2a as an example, since the requirement in the user query is “which route can I take”, the query corresponds to the service type “route”, and the service parameter values are the values of start and destination in the query.

FIG. 2b is a flowchart showing a method for generating the service mapping rule base. First, several sets of actual user queries are gathered from respective service providers. Then, a query corpus is established from the gathered user queries. Here, any semantic analyzing method in the prior art can be utilized to analyze each user query and obtain a semantic analysis result for the purpose of query corpus establishment. Lastly, the similarity between the labeled results of all the queries for each service type is analyzed in the query corpus, and certain service mapping rule is extract from the similarity and written into the service mapping rule base.

For example, the above flow begins with gathering from respective route service providers various common queries, such as “which route can I take to Peiking University from Hailong Building?”, “which route can I take to Qinghe from Zhongguancun?”, etc. Then semantic analysis results are obtained through semantic analysis so as to establish a query corpus. The final step is analyzing all queries for the service type “route” and extracting the common requirement “which route can I take” as well as the common parameters “start” and “destination” so as to generate a service mapping rule regarding “route”. Although the above method generates the service mapping rule base automatically, the base can be manually generated by summarizing various service mapping rules by an operator. Alternatively, the service mapping rule base can be semi-automatically generated, that is, first generating service mapping rules automatically, and then collating them manually.

FIG. 3 shows an example of the user query history base 302, which stores all user query records. Generally, one piece of user query record consists of user, query question, query time, service type and query parameter, and the query parameter can comprises a set of parameters each having a corresponding parameter.

Take the first piece of user query record in FIG. 3 as an example, it represents that Tom made a query of “which route can I take to Tiananmen from Tsinghua East Gate?” at 17:49 on Aug. 1, 2007, in which the service type is “route”, the parameter “start” has a value of “Tsinghua East Gate”, and the parameter “destination” has a value of “Tiananmen”.

The user query history base is generated automatically. To be specific, every time processing on one user query is completed, the system stores as one piece of query record the user, query question, query time, service type and query parameters of the query.

When the user query based on natural language matches a certain rule in the service mapping rule base 301, a service corresponding to the user query can be found. On the other hand, if the existing service mapping rule base cannot encompass the user query, that is, there is no rule matched with the user query, no service can be found corresponding to the user query, and thus the user cannot obtain his/her expected query answer.

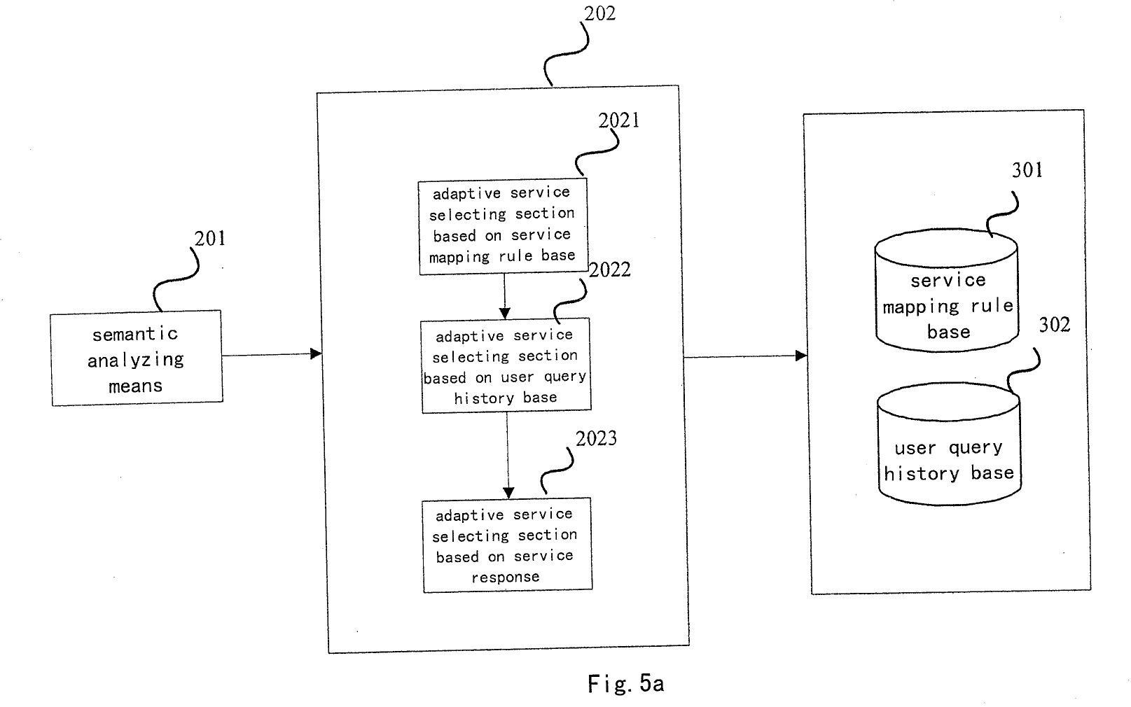

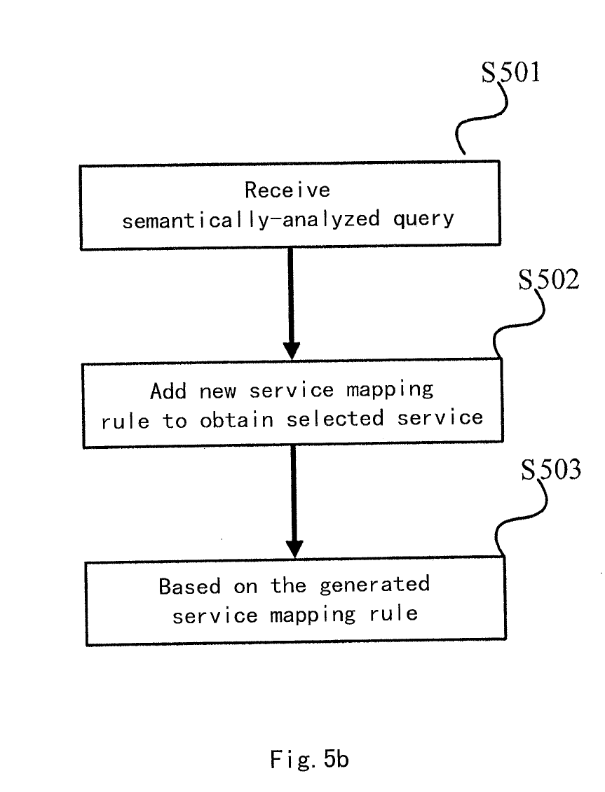

FIG. 5a shows a block diagram of an adaptive service selection means 202 according to the present invention. As shown in the figure, the adaptive service selection means 202 comprises an input section (not shown), an output section (not shown), an adaptive service selecting section 2021 based on the service mapping rule base, an adaptive service selecting section 2022 based on the user query history base and an adaptive service selecting section 2023 based on a service response. When the adaptive service selection means 202 receives an user query analyzed by the semantic analyzing means via the input section, and the user query is not covered by the service mapping rule base, the adaptive service selection means 202 adds a new service mapping rule in the service mapping rule base by use of the adaptive service selecting section 2021 based on the service mapping rule base, the adaptive service selecting section 2022 based on the user query history base and the adaptive service selecting section 2023 based on a service response, and then determines the service selected by the user according to the new service mapping rule. Subsequently, the adaptive service selection means 202 outputs the service selected by the user via the output section. In this way, the required answer can be found. Although the adaptive service selection means 202 in FIG. 5a is shown comprising the adaptive service selecting section 2021 based on the service mapping rule base, the adaptive service selecting section 2022 based on the user query history base and the adaptive service selecting section 2023 based on a service response, it will be appreciated that this adaptive service selection means 202 can include only one of the above three sections 2021, 2022 and 2023 or any combination thereof.

FIG. 5b shows a flowchart of a method for adaptive service selection according to the present invention. The input section receives a user query analyzed by the semantic analyzing means 201 at S501. At S502, at least one of the adaptive service selection means 202 in FIG. 5a is shown comprising the adaptive service selecting section 2021 based on the service mapping rule base, the adaptive service selecting section 2022 based on the user query history base and the adaptive service selecting section 2023 based on a service response functions to add a new service mapping rule in the service mapping rule base so as to obtain a selected service. To be specific, if one of these adaptive service selecting sections cannot handle the query, another of them can be invoked to perform the processing on the query. For example, the query can be processed in the order of the adaptive service selecting section 2021 based on the service mapping rule base, the adaptive service selecting section 2022 based on the user query history base and the adaptive service selecting section 2023 based on a service response, and an optimal result can be selected if each of the three sections has given its processed result and all the results are not exactly the same. The selection strategy can adopt any one of the following three principles:

(a) Majority with priority principle, that is, if the results returned by two of the three sections are identical, the result is considered as the optimal one;
(b) Highest similarity with the priority principle, that is, for example, if the results returned by the adaptive service selecting section 2021 based on the service mapping rule base, the adaptive service selecting section 2022 based on the user query history base differ from each other, the result with the highest similarity is selected as the optimum (the former section 2021 uses the similarity between the requirements of the semantic analysis result and the similar rule, while the latter section 2022 uses the similarity between the syntaxes between the user query and the similar query);
(c) Service response with the priority principle, that is, the optimal result is the result returned by the adaptive service selecting section 2023 based on a service response.

At S503, the output section outputs the selected service to the retrieving means 203 so as to retrieve the expected answer.

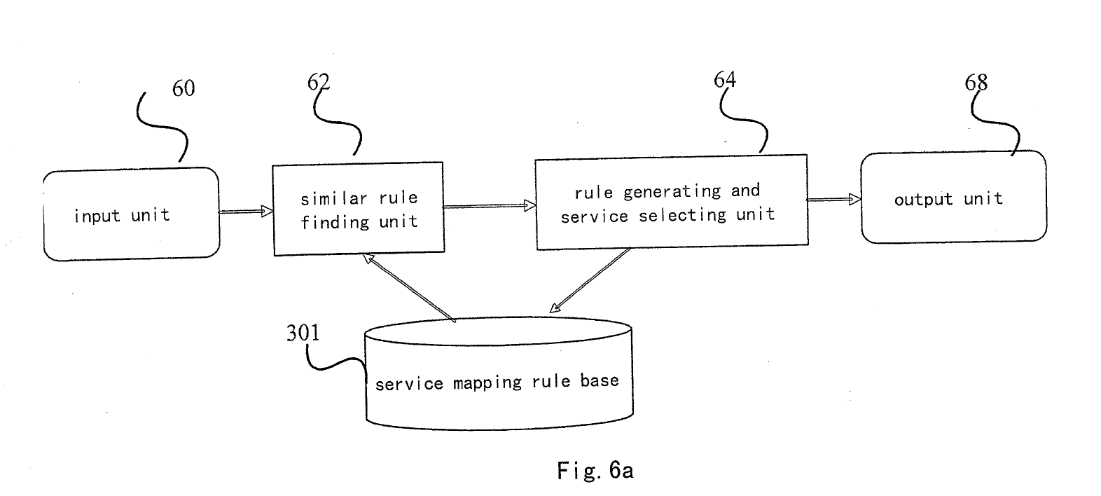

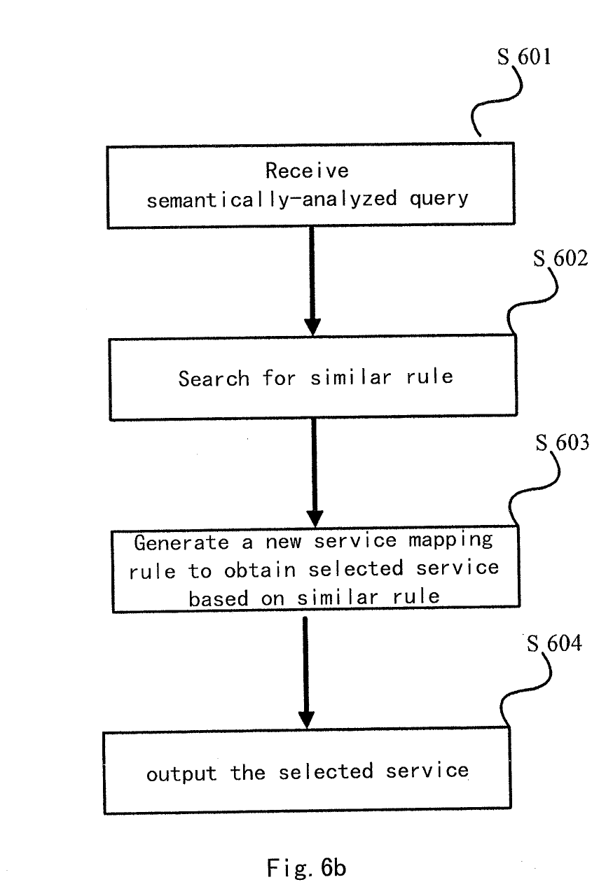

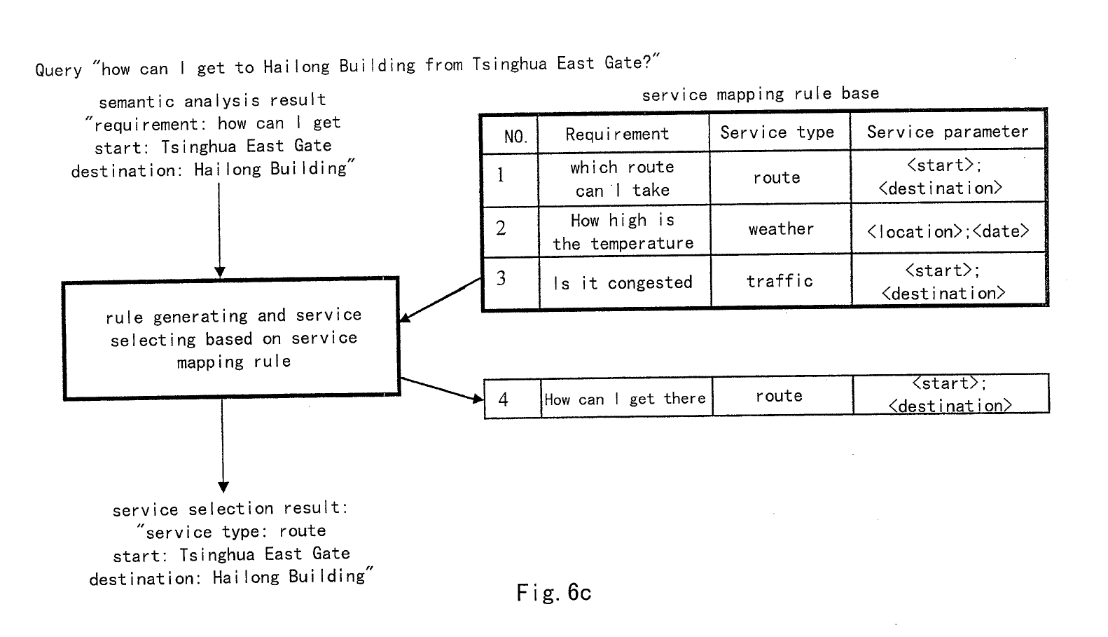

FIG. 6a is a block diagram of the adaptive service selecting section based on the service mapping rule base in the adaptive service selecting means of FIG. 5a. The adaptive service selecting section based on the service mapping rule base includes an input unit 60 for receiving an inputted semantic analysis result of a user query, an similar rule finding unit 62 for finding from the service mapping rule base the rule most similar to the semantic analysis result, a rule generating and service selecting unit 64 for generating a new service mapping rule and determining the selected service corresponding to the user query based on the most similar rule, and an output unit 68 for outputting the determined selected service.

FIG. 6b shows the adaptive service selecting method based on the service mapping rule base. At S601, the input unit 60 receives an inputted semantic analysis result of a user query and sends it to the similar rule finding unit 62, which finds the rule most similar to the semantic analysis result at S602. The similarity between the semantic analysis result and a service mapping rule can be obtained by calculating the similarity between their requirements and the match between their service parameters, and a service mapping rule with the highest similarity is selected as the most similar rule. Here, the similar rule must meet the following conditions:

(1) The requirement of the semantic analysis result is similar to that of the similar rule, and this is determined by semantic similarity and string similarity both of which can be calculated by use of any known method, for example, the semantic similarity can be calculated on the basis of a current semantic dictionary or an ontology base, and the string similarity can be a comparison between strings, for example, “which route can I take” and “which route can I take” are both similar in semantic and string;
(2) The semantic analysis result contains the service parameters defined in the similar rule.

At S603, based on the found similar rule, the rule generating and service selecting unit 64 generates a new service mapping rule that can cover the user query and adds the new rule to the service mapping rule base. The generated new rule is so defined that its requirement is identical with that of the semantic analysis result, its service type is identical to that of the similar rule, and its service parameter is identical with that of the similar rule. Then, the service type is extracted from the new rule to obtain the determined selected service.

At S604, the output unit 64 outputs the determined selected service to the retrieving means so as to retrieve the query answer.

FIG. 6c shows an example of the adaptive service selecting method based on the service mapping rule base. Here, the user query is “how can I get to Hailong Building from Tsinghua East Gate?”, and the semantic analysis result is “requirement: how can I get, start: Tsinghua East Gate, destination: Hailong Building”. Since there is no service mapping rule that matches the query exactly in the service mapping rule base, a similar rule is found, that is, the first rule in the base as shown in FIG. 6c, in which the requirement “how can I get” of the semantic analysis result is similar to the requirement “which route can I take” of the similar rule, and the semantic analysis result contains the parameters “start” and “destination” of the rule. Therefore, a new rule is accordingly generated as “serial number:4; requirement: how can I get; service type: route; service parameter: <start>; <destination>”, and the service type “route” is taken out so as to obtain the determined selected service “service type: route; start: Tsinghua East Gate; destination: Hailong Building”.

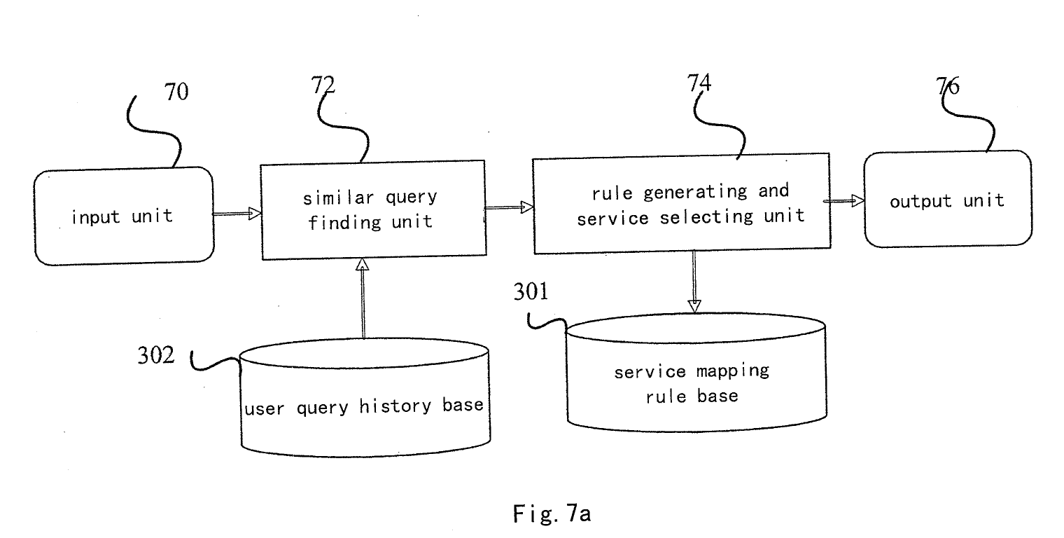

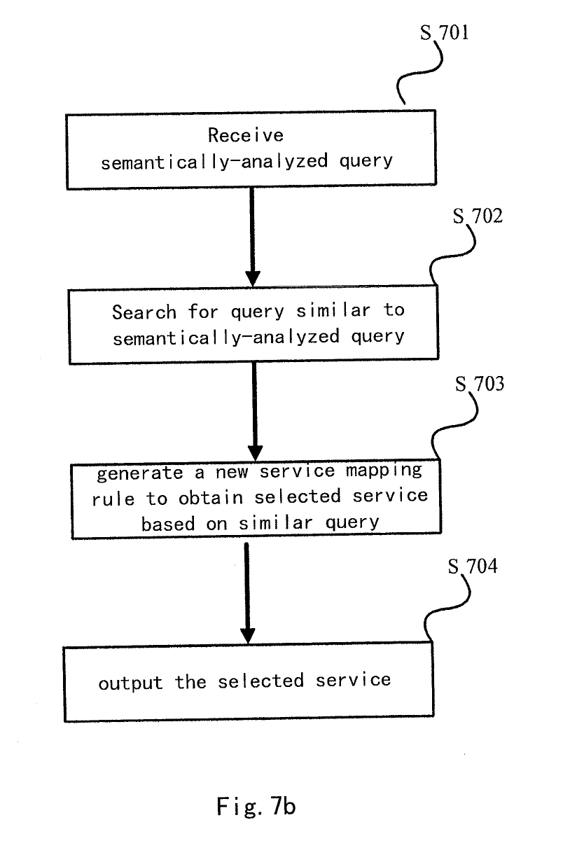

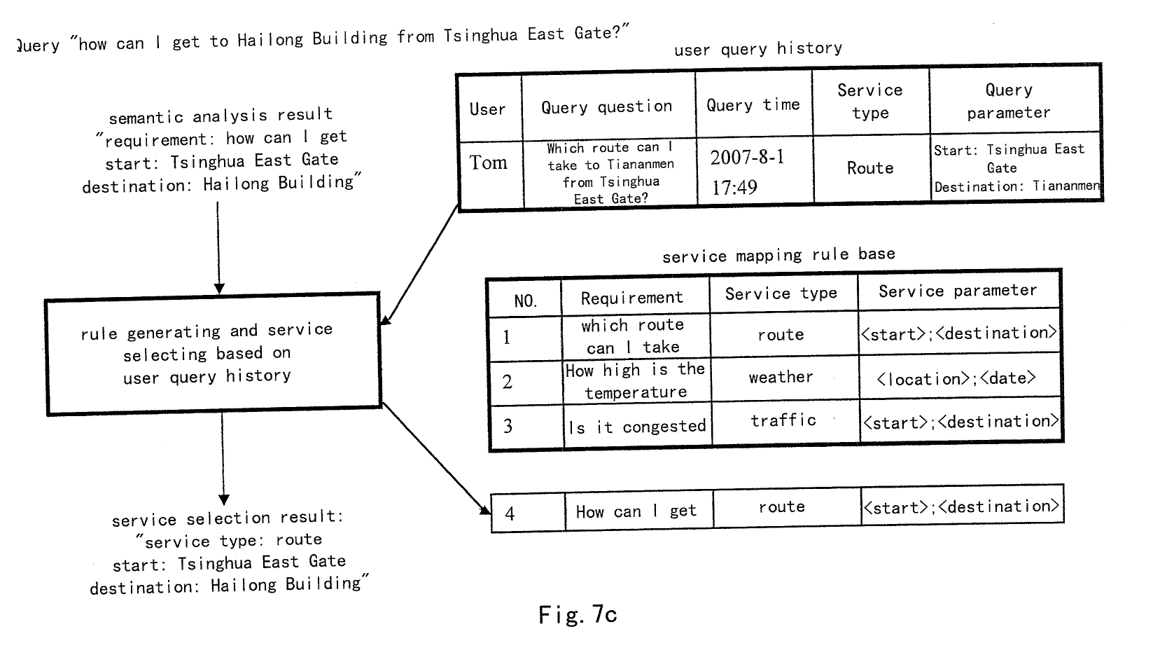

FIG. 7a is a block diagram of the adaptive service selecting section based on the user query history base. This adaptive service selecting section 2022 comprises an input unit 70 for receiving an inputted semantic analysis result of a user query, an similar query finding unit 72 for finding from the user query history base the query similar to the user query, a rule generating and service selecting unit 74 for generating a new service mapping rule band determining the selected service corresponding to the user query based on the found similar query, and an output unit 76 for outputting the determined selected service.

FIG. 7b shows the adaptive service selecting method based on the user query history base. At S701, the input unit 70 receives an inputted semantic analysis result of a user query and sends it to the similar query finding unit 72, which searches the user query history base for the most similar query on the basis of the semantic analysis result of the user query at S702. The similarity between the semantic analysis result and a query can be calculated through parameter comparison and syntactical similarity, and the similar query must meet the following conditions:

(1) The query parameters in the semantic analysis result are identical with those of the similar query;
(2) The values of query parameters in the semantic analysis result are the same or belong to the same category as those of the similar query, the determination as to whether two words belong to the same category can be made by use of any prior art method, such as the method on the basis of a current semantic dictionary or an ontology base, “Hailong Building” and “Tiananmen”, for example, are both belong to the category “location”;
(3) The user query and the similar query are similar syntactically, where the syntactic similarity can be calculated by use of any computation method for string similarity, for example, the method for determining the number of editing operations (add, delete, substitute) required in changing two strings to the same one, and the smaller the number of operations is, the more the two strings resemble. Here, the particular calculation formula is “1−(the number of editing operations/maximal length of two strings)”. Take as an example two strings of “how can I get to Hailong Building from Tsinghua East Gate?” and “which route can I take to Tiananmen from Tsinghua East Gate?”, to change them into the same one, “which route can I take to Tiananmen” must be replaced with “how can I get to Hailong Building”, that is, at least 7 words must be substituted. Further, the maximal length of the two strings is 11 words, and thus they have a syntactic similarity of 4/11 and can be determined as similar to each other.

At S703, based on the found similar query, the rule generating and service selecting unit 74 generates a new service mapping rule that can cover the user query and adds the new rule to the service mapping rule base. The generated new rule is so defined that its requirement is identical with that of the semantic analysis result, its service type is identical to that of the similar query, and its service parameter is identical with the query parameter of the similar query. Then, the service type is extracted from the new rule to obtain the determined selected service.

At S704, the output unit 76 outputs the determined selected service to the retrieving means so as to retrieve the query answer.

FIG. 7c shows an example of the adaptive service selecting method based on the user query history base. Here, the user query is “how can I get to Hailong Building from Tsinghua East Gate?”, and the semantic analysis result is “requirement: how can I get, start: Tsinghua East Gate, destination: Hailong Building”. Since there is no service mapping rule that matches the query exactly in the service mapping rule base, a similar query is found from the user query history base, that is, “which route can I take to Tiananmen from Tsinghua East Gate?”, in which the semantic analysis result and the similar query each contain the parameters “start” and “destination”, the values of “start” are both “Tsinghua East Gate”, the values of “destination” both belong to “location”, and the user query is similar to the similar query in terms of syntax. Therefore, a new rule is accordingly generated as “serial number:4; requirement: how can I get; service type: route; service parameter: <start>; <destination>”, and the service type “route” is taken out so as to obtain the determined selected service “service type: route; start: Tsinghua East Gate; destination: Hailong Building”.

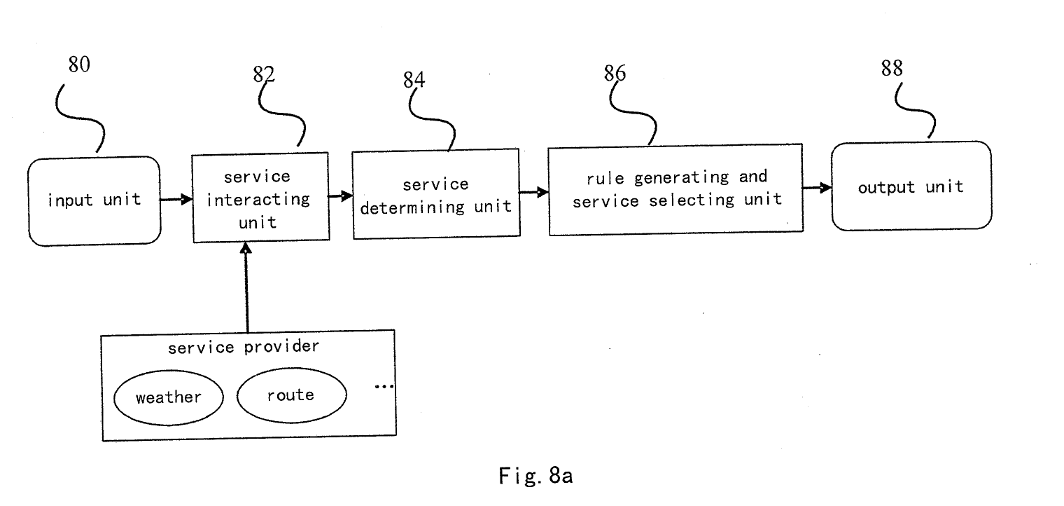

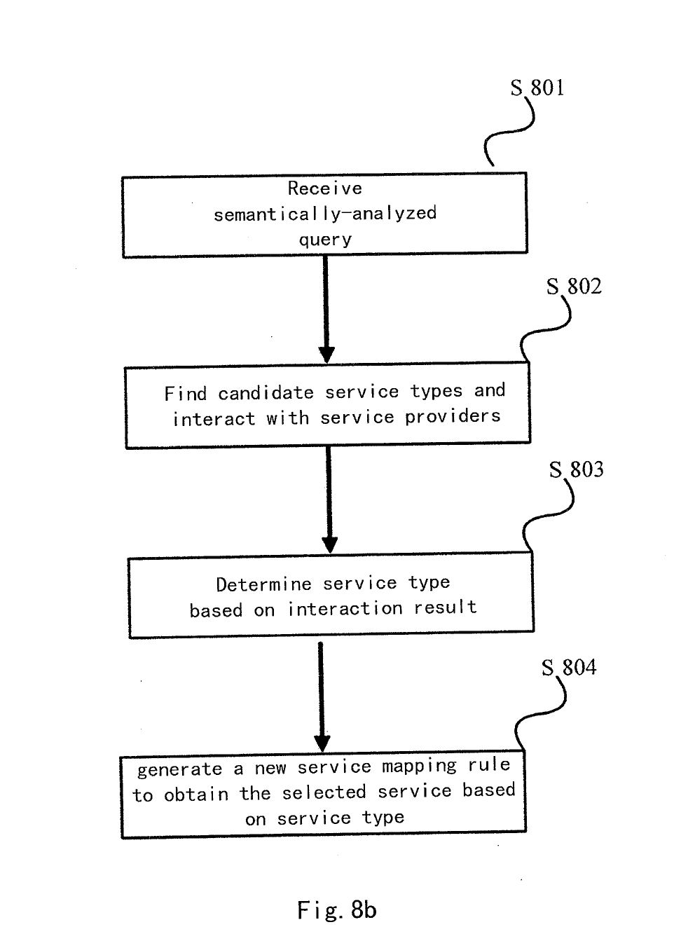

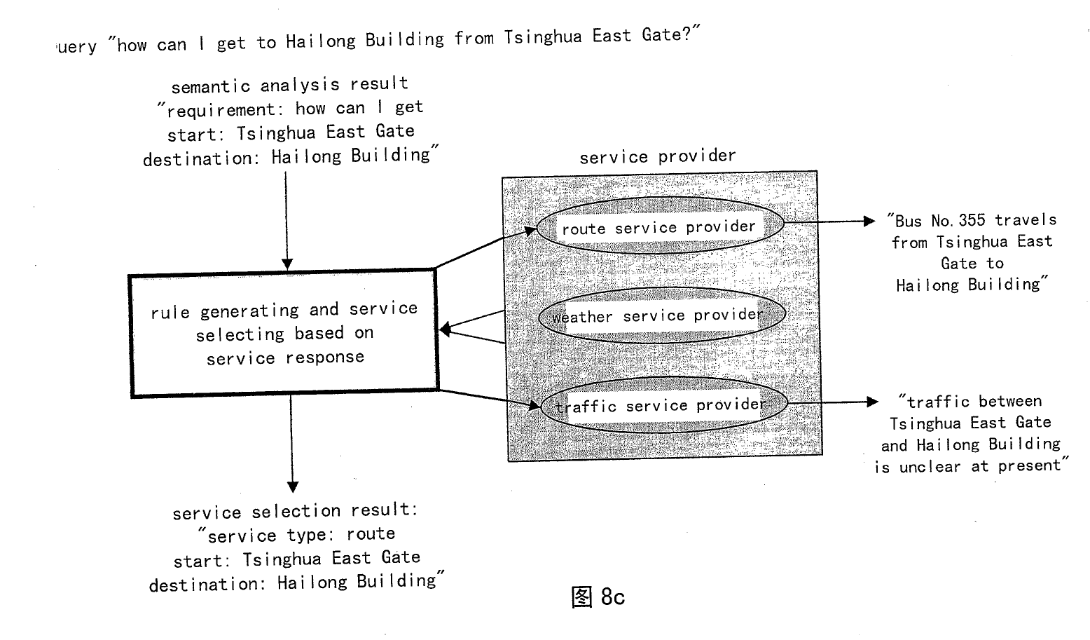

FIG. 8a is a block diagram of the adaptive service selecting section based on a service response, which comprises an input unit 80 for receiving an inputted semantic analysis result of a user query, a service interacting unit 82 for finding candidate service types, sending the parameters contained in the semantic analysis result to service providers corresponding to the candidate service types and receiving the retrieved results returned from these service providers, a service determining unit 84 for selecting a service type with optimal retrieved result from multiple returned retrieved results, a rule generating and service selecting unit 86 for generating a new service mapping rule and determining the selected service corresponding to the user query based on the service type with optimal retrieved result, and an output unit 88 for outputting the selected service.

FIG. 8b shows a flowchart of the adaptive service selecting method based on a service response. At S802, the input unit 80 receives an inputted semantic analysis result of a user query and sends it to the service interacting unit 82, which finds candidate service types and interacts with service providers corresponding to the candidate service types at S802. Specifically, the service interacting unit 82 first searches the service mapping rule base for all service mapping rules which have parameter match with the semantic analysis result and then extracts the service types from these rules as the candidate service types. Here, the parameter match satisfies the condition that the query parameters are the same as the service parameters of the service mapping rule, that is, the number and types of the parameters are the same, respectively. For the definition of such service parameters, reference can be made to the service mapping rule base. Next, the service interacting unit 802 performs service interaction, that is, sends the query parameters of the semantic analysis result to the service providers corresponding to the candidate service types and then receives the retrieved results returned by the providers.

At S803, the service determining unit 84 determines the service types corresponding to the user query based on the returned retrieved results. The determination is conducted specifically in the following manner: (1) if only one service provider returns its retrieved result(s), the service type is selected as corresponding to this provider; (2) if more than one service providers returns their retrieved results, respectively, it is necessary to evaluate the quality of each result and then select the service type corresponding to the service provider providing the result with the highest quality. Here, the evaluation of the quality of each result can be based on a predefined uncertainty-describing dictionary which accommodates description of various certainties, such as those expressions of “not known”, “unknown” and “unclear”. The retrieved result from some service provider is referred to as a low-quality result if it contains description of uncertainty.

At S804, based on the service type obtained above, the rule generating and service selecting unit 86 generates a new service mapping rule that can cover the user query and adds the new rule to the service mapping rule base for update. The generated new rule is so defined that its requirement is identical with that of the semantic analysis result, its service type is that obtained by the service determining unit, and its service parameter is identical with the query parameter of the semantic analysis result. The rule generating and service selecting unit 86 also generates a selected service according to the service type obtained by the service determining unit. Then, the output unit 88 outputs the selected service.

FIG. 8c shows an example of the adaptive service selecting method based on a service response. Here, the user query is “how can I get to Hailong Building from Tsinghua East Gate?”, and the semantic analysis result is “requirement: how can I get, start: Tsinghua East Gate, destination: Hailong Building”. First, service interaction is initiated to find the candidate service types “route” and “traffic” from the service mapping rule base, since the service parameters of the two types match with the query parameters of the semantic analysis result (each of them has two parameters of the type “start” and “destination”, respectively), while the service parameters of the service type “weather” are “location” and “date” which are not matching with the semantic analysis result. Then, the parameters “start: Tsinghua East Gate, destination: Hailong Building” are sent to the service providers for “route” and “traffic”, which returns the retrieved results of “Bus No. 355 travels from Tsinghua East Gate to Hailong Building” and “the traffic between Tsinghua East Gate to Hailong Building is unclear at present”, respectively. Next, service determination is conducted to select the service type “route” as the final result, since the retrieved result from the “traffic” service provider contains an uncertainty word “unclear” and thus falls into the scope of low-quality result. Eventually, a new rule is accordingly generated as “serial number:4; requirement: how can I get; service type: route; service parameter: <start>; <destination>” according to the service type “route”, thereby obtaining the determined selected service “service type: route; start: Tsinghua East Gate; destination: Hailong Building”.

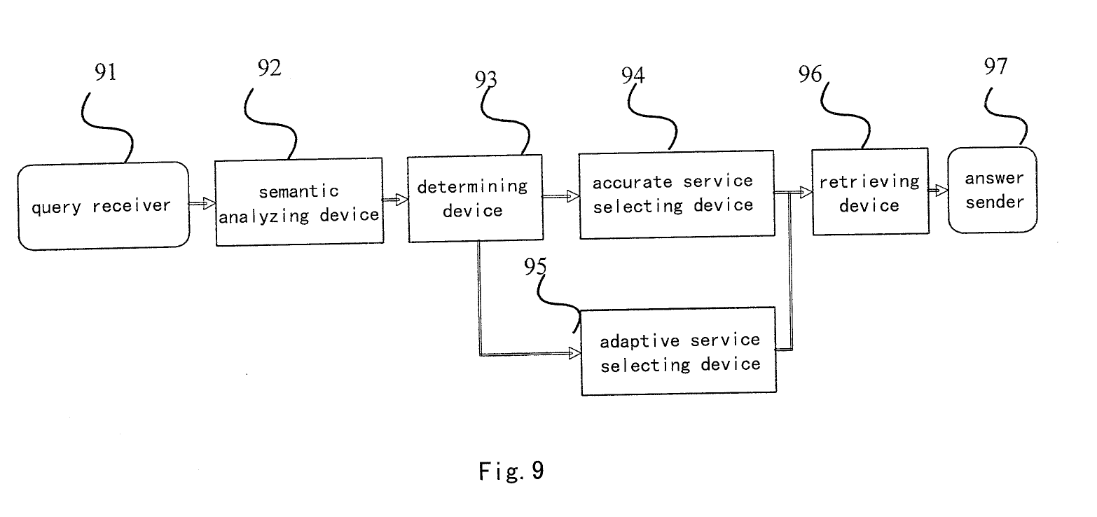

FIG. 9 shows a block diagram of a query system according to the present invention, which differs from the system for adaptive service selection shown in FIG. 1 in that this query system can not only perform accurate query but also make a further query to obtain a selected service as desired by a user even when the user's query does not match with any rule in the service mapping rule base.

Referring to FIG. 9, the system comprises a query receiver 91 which receives a query from a user, a semantic analyzing device 92 which performs word division on the query and then analyzes the divided query semantically, a determining device 93 which determines whether a rule accurately matched with the query can be found in a service mapping rule base, and based on the determination result, sends the semantically analyzed query to an accurate service selecting device or an adaptive service selecting device, an accurate service selecting device 94 which finds the accurately matched rule from the service mapping rule base and extracts from the rule a service type to which the query belongs so as to obtain a selected service, an adaptive service selecting device 95 which adds dynamically a new service mapping rule based on at least one of the service mapping rule base, the user query history base and the response of the interaction with service providers so as to obtain a selected service, a retrieving device 96 which retrieves and obtains an answer according to the selected service obtained by the accurate service selecting device 94 or by the adaptive service selecting device 95, and an answer sender 97 which sends the retrieved answer to the user.

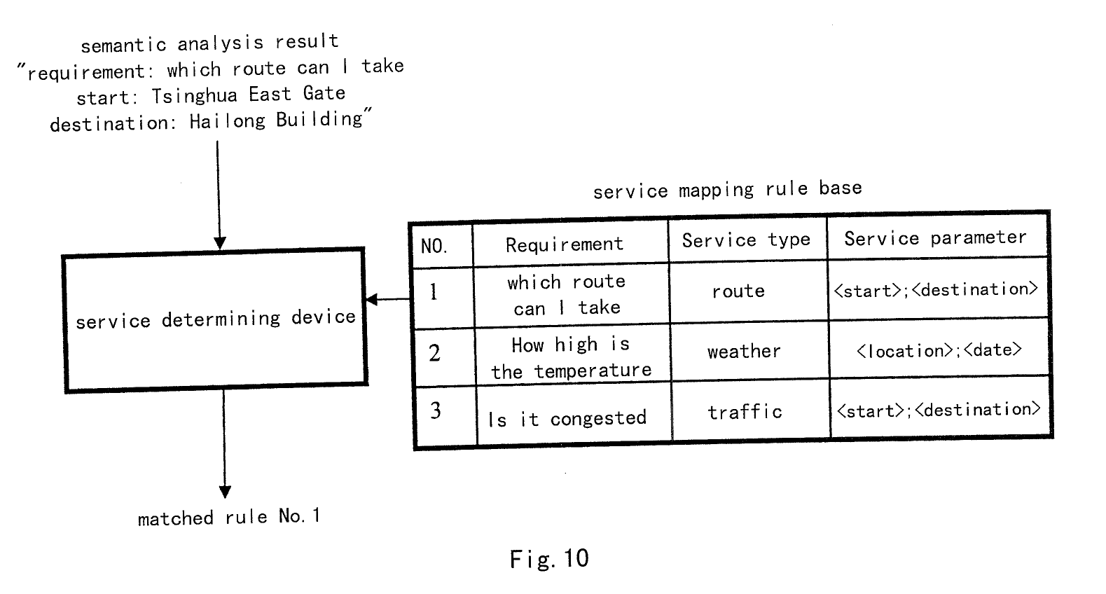

FIG. 10 is an example showing how to obtain an accurate query according to the present invention. An accurate selected service can be generated when the semantic analysis result of a user query matches one of the rules in the service mapping rule base. As an example, the user query is “which route can I take to Hailong Building from Tsinghua East Gate?”, and the semantic analysis result is “requirement: which route can I take, start: Tsinghua East Gate, destination: Hailong Building” and is matched accurately with the first rule in the service mapping rule base, since the common requirement is “which route can I take” and the semantic analysis result of the user query contains all the parameters, “start” and “destination” of the rule. Then, the semantic analysis result and the serial number of the matched rule are both sent to the accurate service selecting device 94 which obtains the selected service, and the corresponding answer is retrieved by the retrieving device and then sent to the user by the answer sender.

FIGS. 11a and 11b show a schematic diagram for applying the device for adaptive service selection according to the present invention to a mobile terminal and an ASP (Active Server Page), respectively. As shown in FIG. 11a, the semantic analyzing device, the service selecting device and the retrieving device can be embedded together into the mobile terminal. Now turning to FIG. 11b, the semantic analyzing device, the service selecting device and the retrieving device can also be embedded into the ASP so that a query is enabled to obtain an answer as desired by a user even when the query inputted by the user does not match with a rule in the service mapping rule base.

While the present invention has been described with reference to the above particular embodiments, the present invention should be defined by the appended claims other than these specific embodiments. It is obvious to those ordinarily skilled in the art that any change or modification can be made without departing from the scope and spirit of the present invention.

What is claimed is:

1. A device for adaptive service selection, comprising:
a semantic analyzing means which analyzes a query from a user semantically;
an adaptive service selecting means which generates a new service mapping rule so as to obtain a selected service, when the semantically-analyzed query does not match with a rule in a service mapping rule base; and
a retrieving means which retrieves and obtains an answer according to the selected service.

2. The device according to claim 1, wherein the adaptive service selecting means comprises an adaptive service selecting section which generates the new service mapping rule so as to obtain a selected service, based on the service mapping rule base.

3. The device according to claim 2, wherein the adaptive service selecting section comprises:
a similar rule finding unit which finds a rule similar to the user query from the service mapping rule base according to the semantically-analyzed query; and
a rule generating and service selecting unit which generates the new service mapping rule based on the similar rule and extracts from the similar rule the service type to which the query belongs so as to obtain the selected service.

4. The device according to claim 3, wherein the similar rule finding unit finds from the service mapping rule base a service mapping rule which meets the following conditions as the similar rule:
the requirement in the service mapping rule is similar to the requirement in the semantically-analyzed query; and
the service parameter in the semantically-analyzed query contains the service parameter in the service mapping rule.

5. The device according to claim 4, wherein the similar rule finding unit determines whether the requirement in the service mapping rule is similar to that in the semantically-analyzed query by calculating the semantic similarity between the requirement in the service mapping rule and that in the semantically-analyzed query.

6. The device according to claim 4, wherein the similar rule finding unit determines whether the requirement in the service mapping rule is similar to that in the semantically-analyzed query by calculating the string similarity between the requirement in the service mapping rule and that in the semantically-analyzed query.

7. The device according to claim 3, wherein the rule generating and the service selecting unit generates the new service mapping rule in such manner that the requirement in the new service mapping rule is identical with that in the semantically-analyzed query, and the service type and the service parameter in the new service mapping rule are identical with those in the similar rule, respectively.

8. The device according to claim 1, wherein the adaptive service selecting means comprises an adaptive service selecting section which generates the new service mapping rule based on a user query history base and acquires the selected service from the new service mapping rule.

9. The device according to claim 8, wherein the adaptive service selecting section comprises:
a similar query finding unit which searches the user query history base for a query similar to the current query from the user; and
a rule generating and service selecting unit which generates the new service mapping rule based on the similar query and extracts from the similar query the service type to which the query belongs so as to obtain the selected service.

10. The device according to claim 9, wherein
the similar query finding unit finds from the user query history a history query which meets the following conditions base as the similar query:
the parameter in the history query is similar to that in the semantically-analyzed query; and
the syntax of the history query is similar to that of the current query.

11. The device according to claim 10, wherein the similar query finding unit determines whether the syntax of the history query is similar to that of the current query by calculating the string similarity.

12. The device according to claim 9, wherein the rule generating and service selecting unit generates the new service mapping rule in such manner that the requirement in the new service mapping rule is identical with that in the semantically-analyzed query, and the service type and the service parameter in the new service mapping rule are identical with those in the similar query, respectively.

13. The device according to claim 1, wherein the adaptive service selecting means comprises an adaptive service selecting section which generates the new service mapping rule based on the service response and acquires the selected service from the new service mapping rule.

14. The device according to claim 13, wherein the adaptive service selecting section comprises:
a service interacting unit which finds candidate service types whose service parameters match with the query parameter in the semantically-analyzed query, sends the query parameter in the semantically-analyzed query to the service providers corresponding to the candidate service types, and receives the retrieved result from the service providers;
a service determining unit which selects a service type whose retrieved result is optimal; and
a rule generating and service selecting unit which generates the new service mapping rule based on the service type determined by the service determining unit so as to obtain the selected service.

15. The device according to claim 14, wherein the service interacting unit determines whether the service parameters of the candidate service types match with the query parameter of the semantically-analyzed query according to whether both the number and the types of the service parameters are identical with the query parameter.

16. The device according to claim 14, wherein the service determining unit selects the service type whose retrieved result is optimal by utilizing a predefined dictionary which describes uncertain words.

17. The device according to claim 14, wherein the rule generating and service selecting unit generates the new service mapping rule in such manner that the requirement in the new service mapping rule is identical with that in the semantically-analyzed query, and the service type and the service parameter in the new service mapping rule are identical with the service type whose result is optimal and the parameter in the semantically-analyzed query, respectively.

18. The device according to claim 1, wherein the adaptive service selecting means comprises:
a first adaptive service selecting section which generates a first service mapping rule based on the service mapping rule base so as to obtain a first selected service;
a second adaptive service selecting section which generates a second service mapping rule based on a user query history base so as to obtain a second selected service; and
a third adaptive service selecting section which generates a third service mapping rule based on a service response so as to obtain a third selected service.

19. The device according to claim 18, wherein the adaptive service selecting means further comprises a service selecting determining unit which determines the selected service according to the majority with priority principle, the service response with the priority principle or the highest similarity with the priority principle, when obtaining a plurality of selected services which are incompletely identical with each other.

20. The device according to claim 1, wherein the adaptive service selecting means comprises:
a first adaptive service selecting section which generates a first service mapping rule based on the service mapping rule base so as to obtain a first selected service;
a second adaptive service selecting section which generates a second service mapping rule based on a user query history base so as to obtain a second selected service, if the first selected service is not acquired; and
a third adaptive service selecting section which generates a third service mapping rule based on a service response so as to obtain a third selected service, if the second selected service is not acquired.

21. A method for adaptive service selection, comprising:
a semantic analyzing step of analyzing a query from a user semantically;
an adaptive service selecting step of generating a new service mapping rule so as to obtain a selected service, when the semantically-analyzed query does not match with a rule in a service mapping rule base; and
a retrieving step of retrieving and obtaining an answer according to the selected service.

22. The method according to claim 21, wherein the adaptive selecting step comprises an adaptive service selecting step of generating the new service mapping rule based on the service mapping rule base so as to obtain the selected service.

23. The method according to claim 22, wherein the adaptive service selecting step based on the service mapping rule base comprises:
a similar rule finding step of finding a rule similar to the query from the service mapping rule base according to the semantically-analyzed query; and
a rule generating and service selecting step of generating the new service mapping rule based on the similar rule and extracting from the similar rule a service type to which the query belongs so as to obtain the selected service.

24. The method according to claim 23, wherein the similar rule finding step comprises the step of finding from the service mapping rule base a service mapping rule which meets the following conditions as the similar rule:
the requirement in the service mapping rule is similar to the requirement in the semantically-analyzed query; and
the service parameter in the semantically-analyzed query contains the service parameter in the service mapping rule.

25. The method according to claim 24, wherein the similar rule finding step comprising the step of determining whether the requirement in the service mapping rule is similar to that in the semantically-analyzed query by calculating the semantic similarity between the requirements in the service mapping rule and the semantically-analyzed query.

26. The method according to claim 24, wherein the similar rule finding step comprising the step of determining whether the requirement in the service mapping rule is similar to that in the semantically-analyzed query by calculating the string similarity between the requirements in the service mapping rule and the semantically-analyzed query.

27. The method according to claim 23, wherein the rule generating and the service selecting step comprises the step of generating the service mapping rule in such manner that the requirement in the service mapping rule is identical with that in the semantically-analyzed query, and the service type and the service parameter in the service mapping rule are identical with those in the similar rule, respectively.

28. The method according to claim 21, wherein the adaptive service selecting step comprises an adaptive service selecting step of generating the new service mapping rule based on a user query history base so as to obtain the selected service.

29. The method according to claim 28, wherein the adaptive service selecting step based on the user query history base comprises:
a similar query finding step of searching the user query history base for a query similar to the current query from the user; and
a rule generating and service selecting step of generating based on the similar query and extracting from the new service mapping rule the service type to which the query belongs so as to obtain the selected service.

30. The method according to claim 29, wherein
the similar query finding step comprises the step of finding from the user query history base a history query which meets the following conditions as the similar query:
the parameter in the history query is identical with that in the semantically-analyzed query; and
the syntax of the history query is similar to that of the current query.

31. The method according to claim 30, wherein the similar query finding step comprises the step of determining whether the syntax of the history query is similar to that of the current query by calculating the string similarity.

32. The method according to claim 29, wherein the rule generating and service selecting step comprises the step of generating the new service mapping rule in such manner that the requirement in the new service mapping rule is identical with that in the semantically-analyzed query, and the service type and the service parameter in the new service mapping rule are identical with those in the similar query, respectively.

33. The method according to claim 21, wherein the adaptive service selecting step comprises an adaptive service selecting step of generating the new service mapping rule based on a service response and acquires the selected service from the new service mapping rule.

34. The method according to claim 33, wherein the adaptive service selecting step based on the service response comprises:
a service interacting step of finding candidate service types whose service parameters match with the query parameter in the semantically-analyzed query, sending the query parameter of the semantically-analyzed query to service providers corresponding to the candidate service types, and receiving the retrieved result from the service providers; and
a service determining step of determining the service type whose retrieved result is optimal when a plurality of retrieved results are returned; and
a rule generating and service selecting step of generating the new service mapping rule a based on the service type determined by the service determining step so as to obtain the selected service.

35. The method according to claim 34, wherein the service interacting step comprises the step of determining whether the service parameters of the candidate service types match with the query parameter of the semantically-analyzed query according to whether both the number and the type of the service parameters are identical with those of the query parameter.

36. The method according to claim 34, wherein the service determining step comprises the step of determining the service type whose retrieved result is optimal by utilizing a predefined dictionary which describes uncertain words.

37. The method according to claim 34, wherein the rule generating and service selecting step comprises the step of generating the new service mapping rule in such manner that the requirement in the new service mapping rule is identical with that in the semantically-analyzed query, and the service type and the service parameter in the new service mapping rule are identical with the service type whose result is optimal and the parameter type in the semantically-analyzed query, respectively.

38. The method according to claim 21, wherein the adaptive service selecting step comprises:
a first adaptive service selecting step of generating a first service mapping rule based on the service mapping rule base so as to obtain a first selected service;
a second adaptive service selecting step of generating a second service mapping rule based on a user query history base so as to obtain a second selected service; and
a third adaptive service selecting step of generating a third service mapping rule based on a service response so as to obtain a third selected service.

39. The method according to claim 38, wherein the adaptive service selecting step further comprises a service selecting determining step of determining the selected service according to the majority with priority principle, the service interaction with the priority principle or the highest similarity with the priority principle, when obtaining a plurality of selected services which are incompletely identical with each other.

40. The method according to claim 21, wherein the adaptive service selecting step comprises:
a first adaptive service selecting step of generating a first service mapping rule based on the service mapping rule base so as to obtain a first selected service;
a second adaptive service selecting step of generating a second service mapping rule based on a user query history base so as to obtain a second selected service, if the first selected service is not acquired; and
a third adaptive service selecting step of generating a third service mapping rule based on a service response so as to obtain a third selected service, if the second selected service is not acquired.

41. A system for adaptive service selection, comprising:
a query receiver which receives a query from a user;
a semantic analyzing device which performs word-division on the query and then analyzes the divided query semantically;
an adaptive service selecting device which generates a new service mapping rule so as to obtain a selected service, when the semantically-analyzed query does not match with a rule in a service mapping rule base;
a retrieving device which retrieves and obtains an answer according to the selected service; and
an answer sender which sends the retrieved answer to the user.

42. A method for adaptive service selection, comprising:
a query receiving step of receiving a query from a user;
a semantic analyzing step of performing word-division on the query and analyzing the divided query semantically;
an adaptive service selecting step of generating a new service mapping rule so as to obtain a selected service, when the semantically-analyzed query does not match with a rule in a service mapping rule base;
a retrieving step of retrieving and obtaining an answer according to the selected service; and
an answer sending step of sending the retrieved answer to the user.

43. A query system, comprising:
a query receiver which receives a query from a user;
a semantic analyzing device which analyzes the query semantically;
a determining device which determines whether a rule accurately matched with the query can be found in a service mapping rule base, and sends the semantically analyzed query to an accurate service selecting device or an adaptive service selecting device;
an accurate service selecting device which extracts from the accurately matched rule a service type to which the query belongs so as to obtain a first selected service;
an adaptive service selecting device which generates a new service mapping rule so as to obtain a second selected service, when the accurately matched rule can not be found in the service mapping rule base;
a retrieving device which retrieves and obtains an answer according to the first selected service or the second selected service; and
an answer sender which sends the retrieved answer to the user.

44. The system according to claim 43, wherein the determining means determines whether the accurately matched rule can be found according to the following conditions:
the requirement in the service mapping rule is identical with that in the semantically analyzed query; and
the query parameter in the semantically analyzed query contains all service parameter in the service mapping rule.

45. A query method, comprising:
a query receiving step of receiving a query from a user;
a semantic analyzing step of analyzing the query semantically;
a determining step of determining whether a rule accurately matched with the user query can be found in a service mapping rule base, and sending the semantically analyzed query to an accurate service selecting step or an adaptive service selecting step;
an accurate service selecting step of extracting the service type and service parameters from the accurately matched rule, so as to obtain a first selected service;
an adaptive service selecting step of generating a new service mapping rule so as to obtain a second selected service, when the accurately matched rule can not be found in the service mapping rule base;
a retrieving step of retrieving and obtaining an answer according to the first selected service or the second selected service; and
an answer sending step of sending the retrieved answer to the user.

46. The method according to claim 45, wherein the determining step comprises the step of determining whether the accurately matched rule can be found according to the following conditions:
the requirement in the service mapping rule is identical with that in the semantically analyzed query; and
the query parameter in the semantically analyzed query contains all service parameter in the service mapping rule.
